(19) United States
(12) Patent Application Publication
(10) Pub. No.: US 2015/0213567 A1
(43) Pub. Date: Jul. 30, 2015

(54) VALUATION OF A REAL PROPERTY WITH AN INTEGRATED TRANSIT SYSTEM

(71) Applicant: EQS, Inc., Austin, TX (US)

(72) Inventor: Teresa Lopez, Austin, TX (US)

(21) Appl. No.: 14/607,992

(22) Filed: Jan. 28, 2015

Related U.S. Application Data
(60) Provisional application No. 61/932,692, filed on Jan. 28, 2014.

(51) Int. Cl. G06Q 50/16; G06Q 30/02

(52) U.S. Cl. CPC G06Q 50/16; G06Q 30/0207; G06Q 30/0278

(57) ABSTRACT

A computerized method and system quantify a value of a green construction project to include a transit system, and modify a real property to integrate the transit system while employing one or more green incentives. The method and system bundle the value of the green construction project for at least one party of interest, and apply the value of the green construction project to one or more financial transactions involving the party of interest.

### BACKGROUND

1 . Field

This invention relates to utility savings in building construction or modification and more particularly relates to valuation of a real property with an integrated transit system.

2. Description of the Related Art

Builders who are concerned about the environment or who wish to save money have undertaken building projects designed to reduce the use of utilities, and in particular to reduce the consumption of nonrenewable energy. Generally, the benefits of such construction are well known.

Many building projects include improved or increased insulation. Others incorporate photovoltaic cells or wind generators. Technologically, consistently building energy-efficient or energy producing homes and offices is achievable. However, higher initial costs for such construction often dissuade builders and buyers from building more energy-efficient buildings. Typically, the buyer must bear the burden of the higher initial costs due to lack of financial incentives and a lack of financing programs that cover energy efficiency or energy producing enhancements. Furthermore, it is often unclear how much benefit such enhancements will provide, and how long it will take to recoup the extra initial cost. Thus, the higher initial costs and uncertainty regarding payback have presented significant barriers to more universal implementation of energy-efficient and energy producing systems in building projects.

Furthermore, because traditional valuation of real property do not adequately include energy efficient systems, a property owner's investment is not likely to be returned. This further dissuades a property owner from integrating an energy efficient system into a real property.

### SUMMARY

From the foregoing discussion, it should be apparent that a need exists for an apparatus, system, and method that offset higher initial costs by assurances of a payback with more definite terms. Beneficially, such an apparatus, system, and method would help to quantify or provide a valuation of a utility savings that is realized through incorporation of a transit system for a real property. Another advantage made possible by such an apparatus, system, and method is the automatic application of a clearly quantified utility savings to one or more financial transactions that have a monetary value corresponding to the quantified savings.

The present invention has been developed in response to the present state of the art, and in particular, in response to the problems and needs in the art that have not yet been fully solved by currently available incentive programs, financing programs, and investment programs. Accordingly, the present invention has been developed to provide an apparatus, system, and method for determining energy savings and/or incentive credit(s) and applying those savings and/or credit(s) to a financial transaction involving a transit system for a real property. The apparatus, system, and method overcome some or all of the above-discussed shortcomings in the art.

An apparatus is disclosed that includes a transit system in property valuation and may include an apparatus including a computer program storage medium readable by a processor and embodying one or more instructions executable by a processor. In one embodiment, the instructions include an analysis module configured to quantify a value of a green transit system and a value of a real property, wherein the value of the transit system based on one or more green incentives. In another embodiment, the instruction include a bundling module configured to integrate the value of the transit system with the value of the real property according to at least one party of interest. In a further embodiment, the instruction include an execution module configured to apply the integrated value to at least one financial transaction on behalf of the at least one party of interest.

In one embodiment, the apparatus further includes a plurality of parties of interest including the at least one party of interest. In another embodiment, the parties of interest are from the group consisting of financial institutions, developers, utility companies, and building owners associated with the real property. In a further embodiment, the bundling module is configured to associate the integrated value to the respective parties of interest. In one embodiment the execution module is configured to apply the integrated value to financial transactions involving the parties of interest.

In one embodiment, the bundling module is further configured to include a value of a green construction project associated with respective parties of interest for a specified geographic region. In another embodiment, the green construction project includes building the transit system. In a further embodiment, a correlation module is configured to correlate the one or more green incentives to the green construction project. In one embodiment, the transit system comprises an electric automobile and the real property comprises a single family dwelling. In another embodiment, the electric automobile provides backup electrical power to the single family dwelling.

In a further embodiment, the transit system includes a mass transit system and the real property includes a commercial building and energy generated by the commercial building provides power to the mass transit system. In one embodiment, the correlation module is configured to selectively combine two or more of the green incentives into a package. In another embodiment, the bundling module is configured to combine a plurality of packages including the package into a bundle associated with the party of interest based on the green construction project and a new construction on the real property.

In one embodiment, the correlation module is configured to correlate all green incentives that are available to the green construction project. In another embodiment, the green incentives are from the group consisting of national tax credits, national tax deductions, state tax credits, state tax deductions, local tax credits, local tax deductions, municipal bonds, qualified energy conservation bonds, clean energy bonds, mortgage bonds, utility company buy backs, utility company rebates, loan guarantees, carbon credits, and renewable energy credits, energy efficiency credits, and builder risk policy energy reduction guarantees. In a further embodiment the analysis module is configured to quantify a value of each of the green incentives that are available.

In one embodiment, the execution module is configured to apply for the green incentive to at least one of a national government, state government, local government, carbon credit securities agency, and utility company. In another embodiment the execution module further includes a forms module that accesses at least one form with which to apply for the green incentive. In a further embodiment, the forms module accesses a plurality of forms corresponding to a respective plurality of recipients. In one embodiment, the forms module is configured to automatically fill in at least a portion of the forms.

In one embodiment, a securities exchange module is configured to apply for carbon credits based on carbon emissions reduction. In another embodiment a securities exchange module is configured to enable purchase and sell of at least one of carbon credits, energy conserving incentive values, and energy generating incentive values. In a further embodiment, the analysis module is configured to determine a baseline value and compare a usage of at least one utility to the baseline value and calculate an energy savings. In another embodiment, the analysis module adds the value of the at least one green incentive to the energy savings for an effectual energy savings value. In a further embodiment, the execution module is configured to apply at least a portion of the effectual energy savings value to the financial transaction.

In one embodiment, at least one of the modules is configured to convert the value of the green incentive and a unit of usage for a utility into a single common unit of at least one of energy and currency. In another embodiment a mortgagor module includes at least a portion of one of the analysis module and the execution module. In a further embodiment, the mortgagor module is configured for setting terms of a loan and applying at least a portion of one of the green incentives to repayment of the loan.

In one embodiment, the analysis module is configured to predetermine a baseline value of energy usage for the real property before the green construction project. In another embodiment, the analysis module further configured to quantify at least one of an actual energy usage and a predicted energy usage for the real property after the green construction project. In a further embodiment, the analysis module compares the at least one of the actual and the predicted energy usage to the predetermined baseline value, and determines a savings of energy. In one embodiment, the execution module is further configured to save at least one of the base line value, actual energy usage, predicted energy usage, and energy savings to a database. In another embodiment, the bundling module is configured to bundle the incentives based on eligibility of at least one of the parties of interest.

A method is disclosed for including a transit system in the valuation of a real property. In one embodiment, the method includes quantifying, without user intervention, a value of a green construction project. In another embodiment, the green construction project includes a transit system. In a further embodiment, the green construction project modifies a real property to integrate the transit system. In one embodiment, the quantifying also includes one or more green incentives. Therefore, in certain embodiments, transit carbon reduction and gasoline reduction credits may be applied to the mortgage instrument. In other embodiments, the transit system may be monetized, collateralized and/or securitized.

In another embodiment, the method includes bundling, without user intervention, the value of the green construction project for at least one party of interest. In a further embodiment, the method includes applying, without user intervention, the value of the green construction project to one or more financial transactions involving the party of interest. In one embodiment, the method includes automatically charging a fee to the at least one party of interest for using the method, wherein the party of interest is from the group consisting of financial institutions, developers, utility companies, and real property owners. In another embodiment, the method includes absorbing an infrastructure cost for the green construction project by applying at least a portion of the one or more green incentives to payment of the infrastructure cost.

In one embodiment, the green construction project is the addition of an electric automobile and the real property is a single family dwelling. In another embodiment, the green construction project is the addition of a mass transit system and the real property is a commercial building. In a further embodiment, the method further includes quantifying at least one of an actual energy usage and a predicted energy usage for the real property after the green construction project. In one embodiment, the method includes comparing the at least one of the actual and the predicted energy usage to the predetermined baseline value. In another embodiment, the method includes determining a savings of energy, wherein the quantifying further considers the savings of energy.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. The invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above is set forth by reference to specific example embodiments that are illustrated in the appended drawings. These drawings depict only typical embodiments of the invention and are not to be considered limiting of the scope. Thus, embodiments of the invention will be described and explained with additional specificity and detail through the use of the accompanying drawings, in which:

FIG. 1 is a block diagram of a system and apparatus for determining a savings in a utility and applying at least a portion of the savings to a financial transaction in accordance with embodiments of the present invention;

FIG. 2 is a another block diagram of a system and apparatus for determining a savings of utilities and applying at least a portion of the savings to a financial transaction corresponding to a portion of the block diagram of FIG. 1 in accordance with embodiments of the present invention;

FIG. 3 is a block diagram illustrating a method for determining a savings and applying the savings to a financial transaction in accordance with embodiments of the present invention;

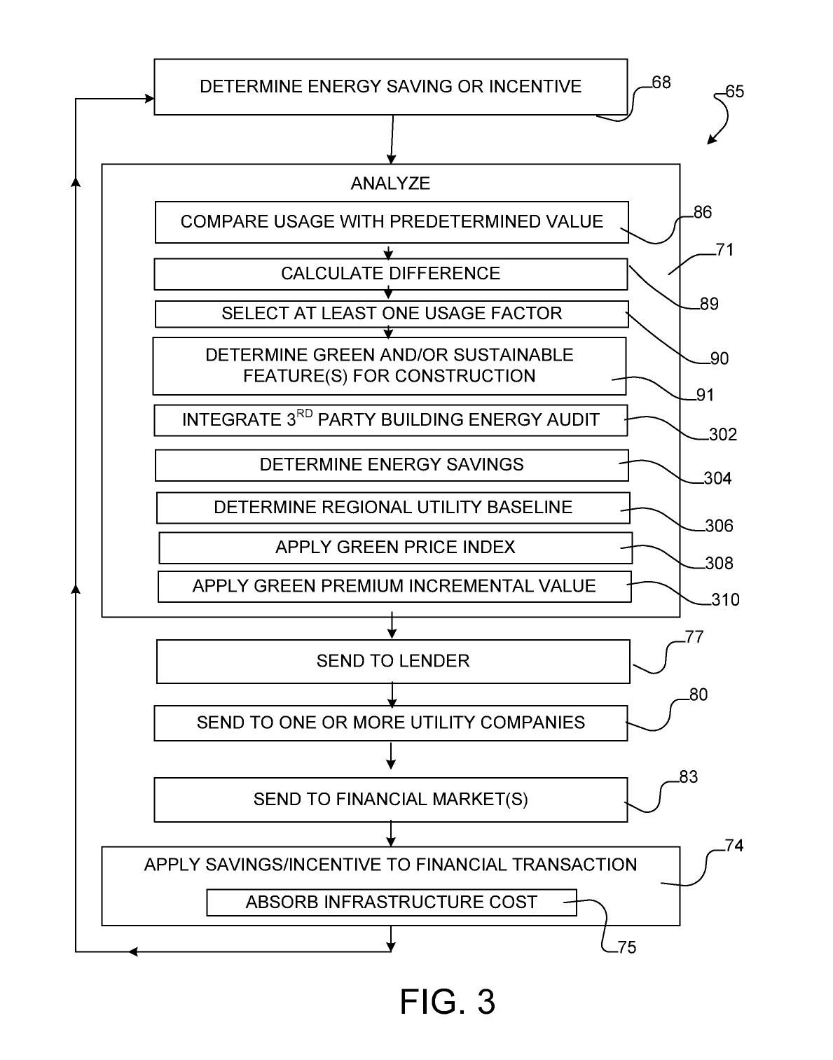

FIG. 4 is a diagrammatic representation of the extensive usefulness of a system for determining a savings in a utility and applying at least a portion of the savings to a financial transaction in accordance with embodiments of the present invention;

FIG. 5 is a graph showing quantified energy reduction values in accordance with embodiments of the system and methods of the present invention;

FIG. 6 is a block diagram showing specifics of one aspect of the system and apparatus for determining a savings in a utility and applying at least a portion of the savings to a financial transaction in accordance with embodiments of the present invention;

FIG. 7 is a flow diagram showing an embodiment of the method, including examples of interacting entities and possible sequences of steps in a new construction or retrofit construction loan process;

FIG. 8 is an example diagrammatic view depicting a user interface presenting the new construction/retrofit construction loan process with selectable options;

FIG. 9 is an illustration depicting one embodiment of a transit system integrated with a real property;

FIG. 10 is another illustration depicting one embodiment of a plurality of electric automobiles integrated with a real property;

FIG. 11 is another illustration depicting one embodiment of a rail transit system integrated with two or more commercial buildings; and

FIG. 12 is a block diagram illustrating embodiments of a method 1265 for determining a utility savings and applying the savings to a financial transaction.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. However, the invention may be practiced without one or more of the specific details, or with other methods, components, materials, and so forth. In other instances, well-known structures, materials, or operations are not shown or described in detail to avoid obscuring aspects of the invention.

This disclosure sets forth building blocks to enable a new universal currency based on resource lending. While the focus of this disclosure is directed to green and renewable energy building construction, it is to be understood that the same principles, apparatuses, and methods may be applied in any industry. For example, loans for green automobiles may have improved terms for the consumer. Furthermore, lenders may benefit from tax credits, carbon credits, and other incentives. One way of benefiting lenders, such as large financial institutions, is by quantifying regional trading capacity. Alternatively or additionally, the automobile industry could reap some of the benefits of the green incentives available through application of the principles described herein. A study of this disclosure will reveal the building blocks for gaining access to as many incentives as are available for energy conserving and renewable energy producing ventures, and in reality this disclosure provides the building blocks for a universal currency for trading these incentive based assets.

In another embodiment, a lender may bundle with bonds and/or other capitalization investments. For example, a green automobile may be combined with a building in securitization. In this example, a lender may monetize the transaction. In another example, depreciation and tax credits may be bundled to offset loan balances, down payments, and/or other equity requirements.

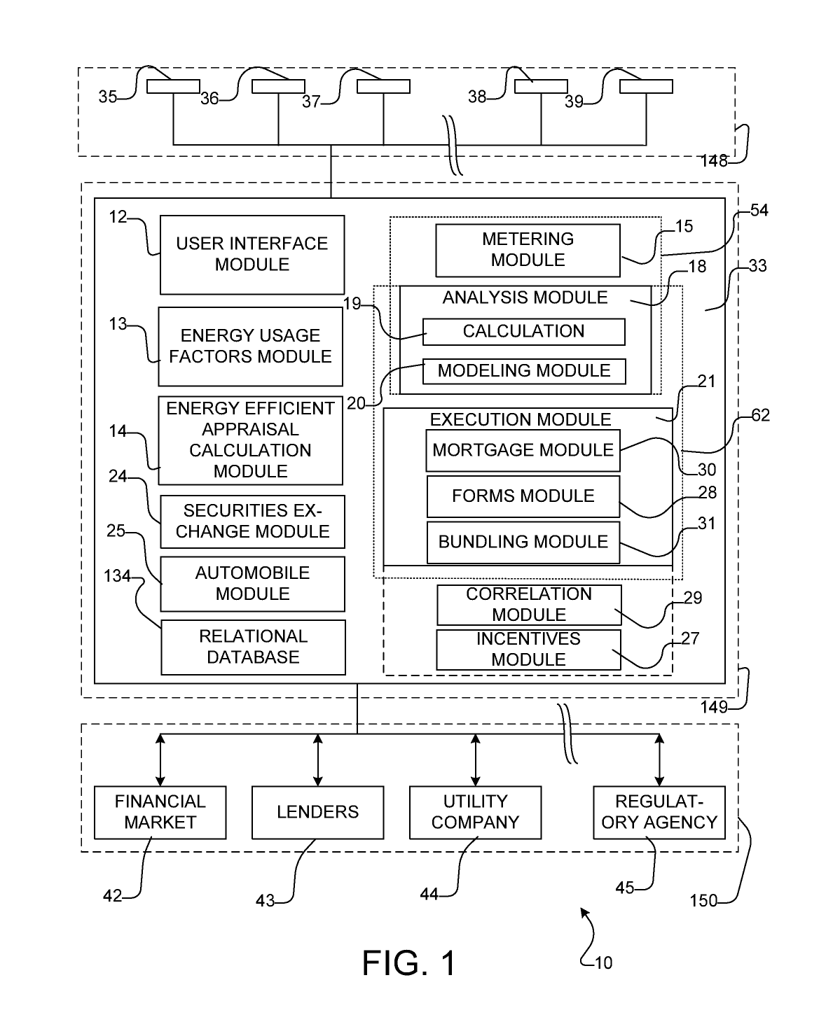

FIG. 1 is a block diagram of an energy quantification system (referred to herein as EQS or system) 10 for determining a savings, (which may be an effectual savings), and applying the savings to a financial transaction in accordance with embodiments of the present invention. The system 10 may include machine-readable code such as software having one or more modules associated with a variety of functions. For example, the code may include a user interface module 12, energy usage factors module 13, energy efficient appraisal calculation module 14, metering module 15, analysis module 18 optionally including calculation and modeling modules 19, 20, and execution module 21. Additional modules may include a securities exchange module 24 and an incentives module 27. Each of the modules may further have submodules. For example, the execution module 21 may include a mortgage module 30. The incentives module may be, or may include, a tax incentive(s) module. The machine-readable code may be stored in memory and incorporated into a computer 33 such as a Web server or other electronic device that includes a processor. It is to be understood that the several modules and components may be in a single electronic device or may be incorporated into a plurality of devices or computers that are interconnected to provide the intended function of the system 10.

In order to determine a savings the system 10 determines a usage of energy for any and all of a plurality of utilities. The system 10 may further include a plurality of detectors 35, 36, 37, 38, 39 that are configured to be associated with a plurality of utilities. For example, detector 35 may be a meter that detects a flow of natural gas to a residential or commercial building and transmits a signal representing the flow of gas to the computer 33 or other electronic device. Detector 36 may be a sensor that detects electrical power usage in the residential or commercial building. Detector 37 may include a meter for determining a flow of water to the building and sending a signal representing the flow to the computer 33. Detector 38 may include a sensor or other metering device indicating a flow, mass, or volume of sewage generated by the building. Detector 39 may be a sensor that detects and signals a quantity of trash in terms of mass or volume. Other detectors may be incorporated without limitation. For example, detectors that measure one or more of electrical current, electrical voltage, and temperature may be utilized. The temperature sensors may be utilized to obtain data for determining a threshold or baseline value with which current energy usage values are compared. The computer 33 or other electronic device may be operably connected to one or more of a plurality of entities that are either interested in the data collected by the computer 33, or from which entities the computer 33 is capable of receiving data. For example, the computer 33 may be connected to one or more entities in financial markets 42, lenders (such as mortgage companies or banks) 43, utility companies 44, and regulatory agencies 45. An integrated transit system may provide some measure of energy for a real property, and therefore, measuring energy consumption may be useful in quantifying a value of the transit system and a value of a real property integrated with the transit system.

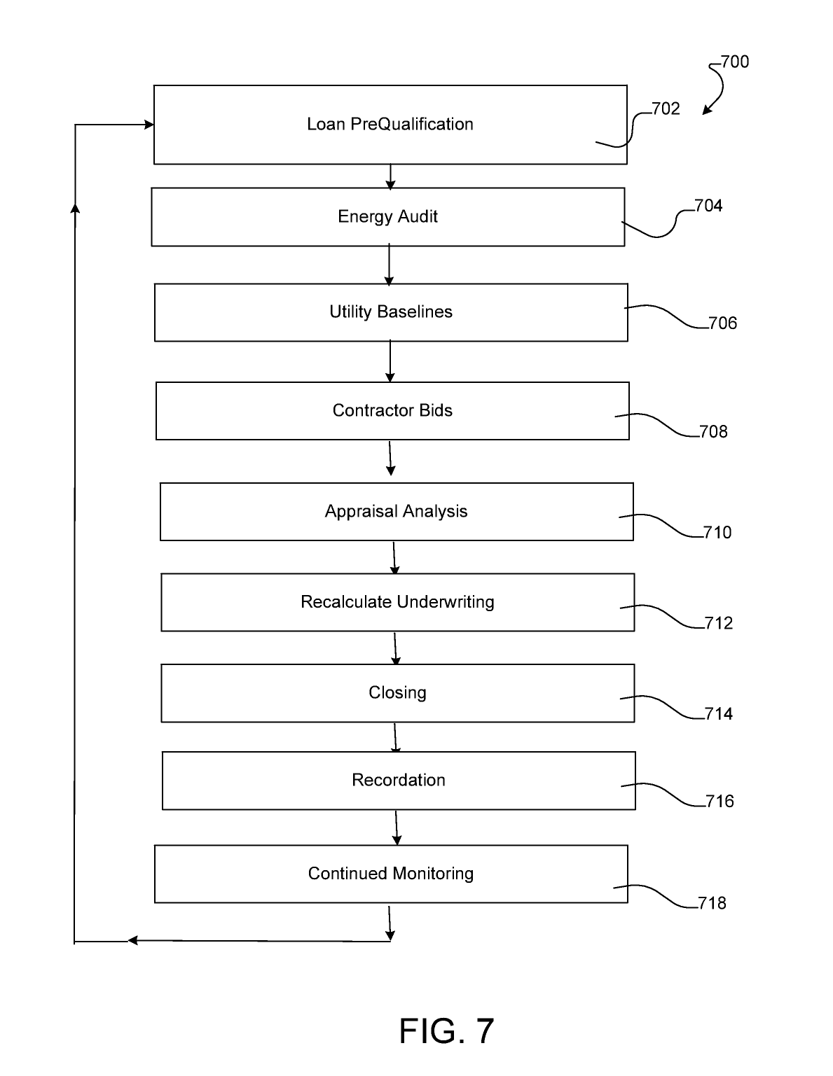

Quantification by prediction may be achieved by accessing databases including data from historical data from utility companies, data collected from measuring usage for similar buildings, heating and cooling systems, appliances, and occupancy patterns. Thus, the database may be created with data sets from manufactures and measurements in buildings having similar energy usage factors. As such, the database may include the relational database 134 discussed in greater detail with regard to FIG. 7 below and data collected from actual use to create baselines for specific buildings having particular energy usage factors. The baselines will vary from one region or climate to another. It is to be understood that the financial markets may include existing or future commodities trading institutions. Thus, carbon credits or other commodities may be bought and/or sold through the system. Furthermore, energy usage data may be averaged from multiple green projects for other real properties and used to help quantify a value of a transit system integrated with a real property.

It is to be understood that certification of carbon credits requires an audit by an authorized independent party. The EQS 10 in accordance with embodiments of this invention may enable such authorized independent auditors to issue certificates to parties of interest through the system 10. Once a green construction project has passed its audit, the auditor can electronically submit the certificate to the party of interest through the EQS 10. Thus, the EQS 10 may verify when carbon or other credits have been certified.

The metering module 15 of the machine-readable code is configured to receive signals from the detectors 35, 36, 37, 38, 39 and quantify the actual usage of the various utilities that is being detected. Alternatively, the actual usage of the various utilities may be determined all or in part by obtaining the usage from another source such as a utility company, through modeling and/or mathematical formulas. The system and apparatuses of embodiments of the present invention are capable of utilizing usage data from other sources or signals representing usage from sensors provided independently of the system and apparatuses of the present invention. The analysis module 18 utilizes historic data and/or engineering modeling data to determine a baseline of usage for each of the utilities. This is achieved by execution of baseline formulas that have been developed to accurately represent the energy usage.

In a simple example, the current temperature and historic weather patterns may be used to calculate a baseline value of energy usage. Then the analysis module 18 determines the actual utility savings by comparing the actual usage to the baseline values. This may be accomplished by simply taking the difference between the actual usage and the baseline values. In one form the savings may be represented in terms of energy reduction (ER), baseline energy usage (BEU), and actual energy usage (AEU) and an equation relating these terms.

ER=BEU−AEU Equation 1

Where part of the value is provided by carbon credits, incentives from utility companies and governments, etc., the savings may be an effectual savings represented in terms including these additions to the value of the savings. These savings may be part of the quantification of energy savings. For example, energy reduction value (ERV) may take into account ER, as described above. ERV for each commodity saved may also take into account carbon reduction (CR) and renewable energy credit (REC). The monetary savings may be represented by taking into the price per unit of each of these factors (EP), (CP), (RP) at a particular point in time, as indicated in a general equation.

ERV=Σ[(ER×EP)+(CR+CP)+(RE+RP)] Equation 2

Other more complex analyses may be undertaken to take into account additional factors. For example, in some cases, the cost of the improvements should be subtracted from the energy savings. The savings minus costs can then be amortized over the life of the improvements at the current interest rate to take into account the time value of the money saved. In other cases, the lender may use a discounted rate and amortization of equipment and building envelope measure life cycle using a present or future valuation method. In this example, an incremental property value may be added to the property value baseline as a “green premium.” Alternatively, the lender can re-amortize the loan after taking into account the saving (minus the costs) associated with the integration of the transit system that will be applied to early repayment. In one embodiment, specific formulas are developed for calculating the energy efficiency on all utilities. In any case, the metering module 15 and the analysis module 18 quantify the usage and the savings, and make these values available in a form that is understandable and useful to one or more users including the various interested entities 42, 43, 44, 45 through a user interface module 12. In this regard, the machine-readable code of embodiments of the present invention is configured to interact with conventional computer programs and machine-readable code in computers utilized by these various interested entities. Thus, the information derived from the formulas and through the analysis is translated into a form usable by the financial and real estate markets.

In one embodiment, the analysis module utilizes any of a variety of mathematical formulas to calculate the baseline value and the savings. The mathematical formulas may incorporate numerous variables that are supplied from among data that includes one or more of geographical regions, weather patterns, temperatures, and building usage times and patterns. The building usage patterns may include occupancy times, heating and cooling requirements, etc. Theoretically, the more variables that are used in this calculation, the more accurate will be the resulting quantification. On the other hand, it is to be understood that some variables will be less significant or negligible relative to others.

The execution module 21 utilizes the data, including data from the analysis module, and any user input to apply at least a portion of the savings to one or more financial transactions. For the purposes of this disclosure financial transactions include one or more of quantification and/or valuation of savings into dollars or other monetary units, prepayment of a loan, purchase of a commodity, request for an incentive credit, initiation of application for a tax credit, etc. In the embodiments shown in FIG. 1, the execution module 21 includes a mortgage module 30 for controlling early repayment of a mortgage loan based on the utility savings. It is to be understood that the mortgage module 30 could be separate from the execution module 21 and still function together with the execution module 21 to implement repayment of the mortgage loan. Although shown separately, the securities exchange module 24, the incentives module 27, and/or other modules could be incorporated into the execution module 21.

In particular, the machine-readable code on computer 33 or other electronic device may be configured to interface with mortgage companies or other lenders for the purpose of transmitting quantified data representing energy usage, credits earned, incentives qualified for, and/or energy produced. Additionally or alternatively, the computer 33 or other electronic device may interface to transmit quantified saving data including energy savings and/or other utility savings so that the mortgage companies can apply at least a portion of the savings to early repayment of mortgagee's loans. The machine-readable code may also be configured to automatically and regularly remit a predetermined portion of the savings as an early repayment of the loan.

The machine-readable code is configured to interact with a utility company 44, for example, to receive historic and/or current data on a usage of a utility. The historic data may be used by the analysis module 18 to compare the historic data to the current usage data and to determine the utility savings. Alternatively or additionally, the machine-readable code may be configured to supply data to the utility company 44 for comparison with their records of usage and/or for sending data indicating a quantity of energy put back into the grid by the building when the building is an energy producing structure. In one example, an electric vehicle may provide electrical power for a real property such that no power is consumed for some period of time from a municipal power source.

The machine-readable code may include the securities exchange module 24 that is configured to interact with companies in the financial market 42 for the purpose of purchasing securities or for selling carbon credits, for example. Thus, data representing the purchase or sale values of at least a portion of the utility savings may be transmitted by the securities exchange module 24 to the financial market 42. Similarly, data representing market values of the securities or carbon credits may be transmitted from the financial market to the computer 33 or other electronic device. In another embodiment, a securities exchange module 24 may be configured to enable purchase and sell of carbon credits, energy conserving incentive values, energy generating incentive values, or the like.

The machine-readable code may also be configured to interact with one or more regulatory agencies for the purpose of receiving data or other information regarding interest rates, tax incentives, and/or carbon credits, for example.

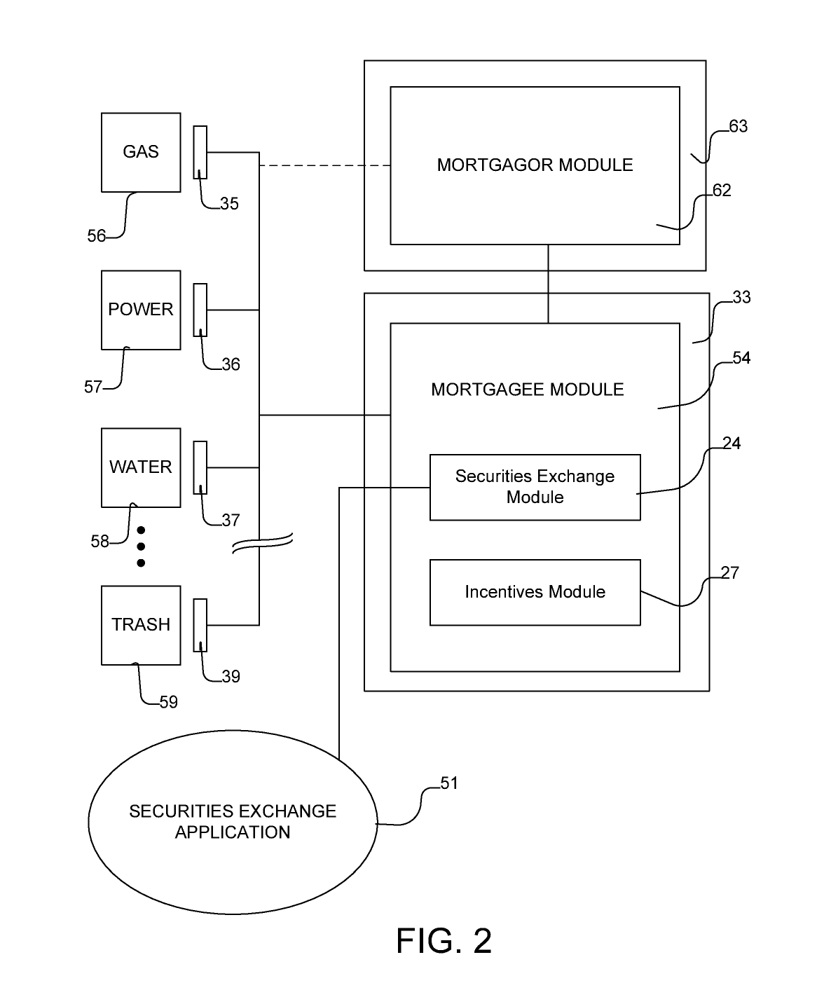

As shown in the specifics of FIG. 2, the apparatus for determining energy usage, determining a related savings of a utility, and applying at least a portion of the savings to a financial transaction may further include the securities exchange or trading module 24 that is configured to interface with the execution module 21 (shown in FIG. 1) and a securities exchange application 51 that may be available in the financial market 42 for automatically applying at least a portion of the savings to investment in a securities exchange market. The securities exchange application 51 may be one of several applications belonging to respective trading institutions throughout the country and/or around the world. As such, the securities exchange module 24 is configured to interface with a variety of applications and is capable of sending and receiving data in a compatible or converted form. In this way, the execution module 21 can interface with the security exchange institutions to buy and sell carbon credits, renewable energy credits (RECs), and/or other incentives of value. Alternatively, the securities exchange application 51 may be integrated as a non-remote module in the apparatus, and may receive regular or frequent updates to data from the financial market.

An automobile module 25 may also be included for analyzing savings and credits associated with green features on automobiles. The automobiles may have green features that are provided by the original manufacturer or that are retrofitted to the vehicles. As with real estate property improvements, values of green features on automobiles may be quantified, bundled, and/or applied to transactions for individuals or companies. Automobile manufactures may benefit greatly from bundled values of carbon credits or other credits that may be traded or sold.

FIG. 2 also shows the securities exchange module 24 and the incentives module 27 forming part of a mortgagee module 54. It is to be understood that the mortgagee module 54 may include all of the modules and submodules shown in FIG. 1. Alternatively, the mortgagee module 54 (represented by the dashed line labeled 54 in FIG. 1) may include at least a portion of at least one of the analysis module 18 and the metering module 15. The mortgagee module 54 may be supported on a computer 33 or other electronic device located at the mortgagee's building, for example. Thus, the detectors 35, 36, 37, 39 may be directly associated with respective utilities such as gas 56, power 57, water 58, and trash 59, for example. That is, sensors, meters, and/or other detectors may be placed on gas, power, and water lines or meters as needed. The detectors 35, 36, 37, and 39 are operatively connected to the computer 33 or other electronic device in order to transmit signals representing usage of the various utilities. It is to be understood that the connection between the computer 33 or other electronic device and the detectors or other devices may be wired or wireless connections.

While the machine-readable code providing the various modules shown in FIG. 1 may be configured to interface with conventional computer programs and code utilized by interested entities 42, 43, 44, and 45, these interested entities may alternatively have respective modules loaded on their computers for interfacing with the various modules shown in FIG. 1. Thus, FIG. 2 shows a mortgagor module 62, which may be supported on a computer 63 located at one of the lenders corresponding to lenders 43 in FIG. 1. It is not required that the modules shown in FIGS. 1 and 2 be located at the user's or mortgagee's building. In fact, in one embodiment, all the modules shown in FIG. 1 may be incorporated into the mortgagor module 62 of FIG. 2. In this case, the mortgagee module 54 would not need the securities exchange module 24 and the incentives module 27 because they would be included in the mortgagor module 62. Signals representing the utilities usage could be transmitted by a wired or wireless connection from the user or mortgagee's building to the mortgagor module 62 at the mortgage company. While the mortgage company has a direct interest in applying the utility savings to early payment of a mortgage loan, the machine-readable code and modules on the computer 63 at the mortgage company could still implement investment in securities and initiation of incentive credit and/or tax credit requests for the mortgagee. Alternatively, these credits could be received by the mortgagor or developer in exchange for improved loan terms to the mortgagee.

In an alternative embodiment, a dashed line labeled 62 in FIG. 1 shows the mortgagor module 62 including at least a portion of at least one of the analysis module 18 and the execution module 21.

It is to be understood that the number and type of utilities monitored to quantify usage, and the utility savings to be quantified in accordance with the embodiments of the present invention is unlimited. While FIGS. 1 and 2 show gas, power, water, sewer, and trash, other utilities may be monitored for savings as well. For example, other fuels such as heating oil, coal, alcohol, gasoline, diesel fuel, etc. may be additionally or alternatively monitored and quantified. Still, the metering and analysis modules determine usages of the plurality of utilities and compare the usages with predetermined baseline values of the respective utilities to quantify savings.

While the various modules have been described as providing a system and apparatus for determining a savings in a utility and applying at least a portion of the savings to a financial transaction, it is to be understood that such a system and apparatus may include as few as one of the modules described, or may include more than the number of modules shown and described. In any case, the system an apparatuses described herein may be used to implement embodiments of the method of the present invention described below.

The schematic flow diagrams that follow are generally set forth as logical flow diagrams. As such, the depicted order and labeled steps are indicative of embodiments of the presented method shown in respective figures. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Determining 68 an energy saving or an incentive, analyzing a savings associated with the usage, and applying at least a portion of the savings to a financial transaction. In a specific case, determining the energy savings includes detecting or determining a usage of a least one utility 56, 57, 58, 59. Also in a specific case, the savings is applied in a way that absorbs infrastructure costs. For example, a portion of the green incentives may be used for payment of infrastructure costs. Additional embodiments include sending 77 data to a lender such as a mortgage company, sending 77 data to one or more utility companies, and sending 83 data to one or more entities in the financial markets. As may be appreciated, embodiments of the method may include receiving data from one or more of the lender, utility companies, and entities in the financial markets. Applying at least a portion of the savings to a financial transaction may simply consist of valuating a savings in a utility usage. On the other hand, applying at least a portion of the savings may include one or more of making an early payment on the principle of a loan, obtaining credits for energy or other utilities conserved or produced, and investing in the financial markets.

In one embodiment, methods for securitizing green assets are disclosed. In one embodiment, a green MBS portfolio may include Energy Efficiency Credit (EEC) and Renewable Energy Credits (REC). In another embodiment, a green MBS portfolio may include asset rating labels associated with a building energy quotient (BEQ). In another embodiment, a green MBS portfolio may include a building performance risk policy that includes a life cycle of a green energy project. In another embodiment, a green MBS portfolio may include a building performance index (BPI), and/or a sustainability price index (SPI). Therefore, in certain embodiments, a green energy portfolio may include many different factors that may affect a resulting securitization value of a green asset.

In one embodiment, the step of determining or detecting usage includes detecting usages of the plurality of utilities 56, 57, 58, 59. As may be appreciated, depending on the utility being detected, detecting may include sensing at least one of mass, volume, flow, current, energy, and temperature. Signals representing usage of the one or more utilities are received and analyzed. This may be done in real-time, resulting in quantification of real-time energy usage. The step of analyzing may further include comparing the usage with a predetermined value, and calculating a difference between the actual usage and the predetermined value. The predetermined value may be a baseline, as discussed in other parts of this disclosure. Thus, applying at least a portion of the savings may include applying at least a portion of the difference between the actual usage and the predetermined value to the financial transaction. Alternatively or additionally, the step of analyzing 71 may include selecting at least one usage factor 90. For example, the method may include selecting a climate or climate region, and accessing data associated with that climate.

By accessing temperatures and wind speeds, for example, the step of analyzing can pull up data and/or calculate a base line usage of energy to which an actual usage may be compared. In one example, the data may be real-time data of actual savings as measured by various sensor installed at a real property. In another example, the data may be regional data based on regional calculations of energy usage for various types of energy resources. In another example, the data may be based on typical energy usage calculations for similarly configured properties. Alternatively or additionally, the step of analyzing can calculate a predicted usage of energy with one or more green and/or sustainable features incorporated into a building. Likewise, analyzing 71 may include determining a green or sustainable feature for construction 91.

In other embodiments, analyzing 71 may include integrating 302 a 3^{rd} party energy audit. Therefore, in certain example, an energy auditing entity may analyze energy usage for a building and the analysis may include results from the energy audit from the 3^{rd} party.

In another embodiment, analyzing 71 may include determining 304 an energy savings. The energy savings may or may not be based on the analysis 71. The energy savings may include a net decrease in energy consumption, based on one or more green energy projects. In one embodiment, analyzing 71 may include applying 308 a green price index. A green price index may indicate an approximate cost-of-living analysis. By including transportation costs in a real property transaction, a more accurate value of a green energy project may be calculated based on the effects of the green energy project on other cost-of-living factors, such as, but not limited to, energy usage, product procurement, transportation costs, communication costs, limited resource usage, renewable resource usage, or other, or the like.

In another embodiment, the analysis 71 may include applying 310 a green premium incremental value. In one example, based on a type of a green construction project, pre-calculated or pre-determined approximate values may be included in an analysis 71. These pre-calculated values may be incremental based on historical time of use, a historical amount of resource use, historical throughput, an amount remaining on a mortgage that includes a green energy project, or other, or the like. In certain examples, the historical values may be based on other similar green energy projects in similar areas.

One of the benefits of the embodiments of the method in accordance with the present invention is that the steps of detecting, analyzing, and applying may be achieved automatically under the control of instructions embodied in machine-readable code that may be stored in storage media or memory of a computer, or that may be supported on an electronic device. Similarly, the steps of sending and/or receiving from lenders, utility companies, and entities in the financial markets may also be automated. Thus, all or part of the utility savings may be automatically applied to one or more of early payment on a loan principal, request for credit, investments in financial markets, securitization through GSEs, bonds, private capital pools and/or other investment vehicles.

It is pointed out that embodiments of the system and method in accordance with the present invention that access data from multiple data sets and sources, and provide them through a single application together with the standardization of energy usage and savings units also make possible the application of these savings to financial transactions substantially universally. Much must be done going forward to develop and backfill the database that provides green and sustainable energy information for global markets. The way the database is organized and maintained provides a blueprint for managing green and sustainable energy information. Green and sustainable energy may include green assets, carbon and energy reduction savings from an associated transit system with appropriate technology equipment and a building envelope. This database and the quantification described herein streamline applying energy savings to financial transactions. In a specific application, the database and quantification streamline processes for monetization and securitization of mortgage loans for environmentally friendly buildings. Applying energy savings and credits to financial transactions in accordance with embodiments of the present invention move participants toward energy and financial independence. Therefore, in certain embodiments, a property that may generate more energy than it uses (a net-zero property) may create incentives for both consumer markets and stakeholders of the real property, such as, but not limited to, lenders, builders, developers, or the like.

The database includes data on tax credits, tax deductions, and other incentives. Furthermore, the database includes forms for applying for the various incentives programs. The system 10 include a forms module 28 configured to automatically fill in and/or submit the forms that it accesses from the database on behalf of the participants.

Embodiments include methods of doing business, which may include one or more software programs that enable the business methods. One of the advantages of the methods and the related technology that is incorporated into associated apparatuses and systems is that they facilitate a quantification of energy savings in building construction. In one embodiment, the quantification of the savings allows mortgages to be issued based on the amount of savings anticipated and to then directly tie mortgage payments to the actual savings. This embodiment of the method enables approval of loans having better terms for the borrower and/or facilitates accelerated loan payoff. In one example, loan terms may reduce risk for investors and/or building owners by providing increased assurance that payments for a loan can be made by the real property owner, or other, or the like. Embodiments of the invention also facilitate securities trading based on one or more of anticipated savings, actual savings, carbon credits, and net savings. Other embodiments may include a combination of the mortgage program and securities trading in which sale of carbon credits or other investments may be tracked by the software. In another embodiment, ensuring consumer engagement may provide additional utility benefits. Energy reductions may offset future infrastructure costs which may achieve mandated energy reduction and renewable energy generation goals. This may also enhance operational integrity and energy-building performance over a life of a loan.

For the purposes of this disclosure, net savings means incentives paid by electric and other public utility companies for energy or other utility benefits produced at a business or residence that is/are returned into the grid system. These, like the other savings, may be applied to repayment of a mortgage loan. Other types of incentives paid by these utility companies or the government could also be applied in embodiments of the method. These incentives may include credit incentives, rebates, and/or tax deductions for switching to more energy efficient furnaces, increasing insulation, building green, etc.

Software may be applied at the residence or commercial building that is being upgraded or built with energy efficient or energy producing features. The software may be run on a computer at the residence or commercial building. Alternatively or additionally, other digital processing devices may be utilized. For example, a microprocessor or programmable logic controller (PLC) may be configured to carry out one or more of the steps of detecting, analyzing, and applying. The microprocessor may also be configured to send and/or receive signals to and from one or more of lenders, utility companies, and financial markets. Signals may be sent and received through wired or wireless network(s). Sensors may be placed on the electricity meter and other locations for monitoring power, gas, and other utilities to determine the amount and cost of the utilities being used.

In one embodiment of the method, a computer or other digital processing device collects the data and uploads it to a server running at a mortgage company facility. Software and/or some other digital processing mechanism at the mortgage company calculates the amount of energy expended, the cost of that energy, and the actual saving as compared to a baseline value during a predetermined period of time. In another embodiment, the digital processing mechanism may be initiated after the loan closes and is sent to a loan service provider.

The amount of savings is then applied to the mortgagee's loan principle, accelerating the loan repayment. The money can either be directly withdrawn from the banking account of the mortgagee, or applied in some other manner. It is to be understood that similar embodiments could be applied through software and/or other digital processing devices located at the residence or commercial building for which the loan has been issued, or at a completely separate location. Whether performed electronically or otherwise, at least a portion of the savings may be applied to repayment of the loan principle to accelerate repayment.

In one embodiment, the method includes drawing up a mortgage that provides favorable terms based on the anticipated energy savings. In another embodiment, the method includes contractually binding the mortgagee and the mortgage company to accelerate repayment of the mortgage based on the amount of actual savings, or bundled incentives that may create additional revenues, such as, but not limited to, carbon credits, green tags, white tags, utility rebates, or other, or the like. That is, a contract would give the mortgage company the right to automatically apply at least a portion of the savings to early payment on the principle of the mortgage loan. The amount of the savings to be applied may be a predetermined maximum or a percentage of the savings, and may be written into the contract. Software and/or other digital processing devices may be installed at the mortgagee location and/or the mortgagor's facility. The sensors or other detectors may be installed on one or more of the electric meter and various other locations. The software may also tie into one or more of carbon credit trading locations, net savings locations such as utility companies, and other incentive savings locations such as governmental agencies. The software and/or other digital processing devices then collect data regarding energy and/or other utility usage over the course of the month, for example. Incentives for which the savings qualify the mortgagee and/or mortgagor may be tabulated and uploaded to the mortgage company. The mortgage company calculates the savings, applies the savings to accelerate the mortgage payment, and sends a bill reflecting the early payment to the mortgagee, (or the mortgage company otherwise receives payment on the accelerated basis.) It is to be understood that the same detecting, quantifying, and applying of usage and savings may be managed by one or more entity other than the mortgage company without limitation.

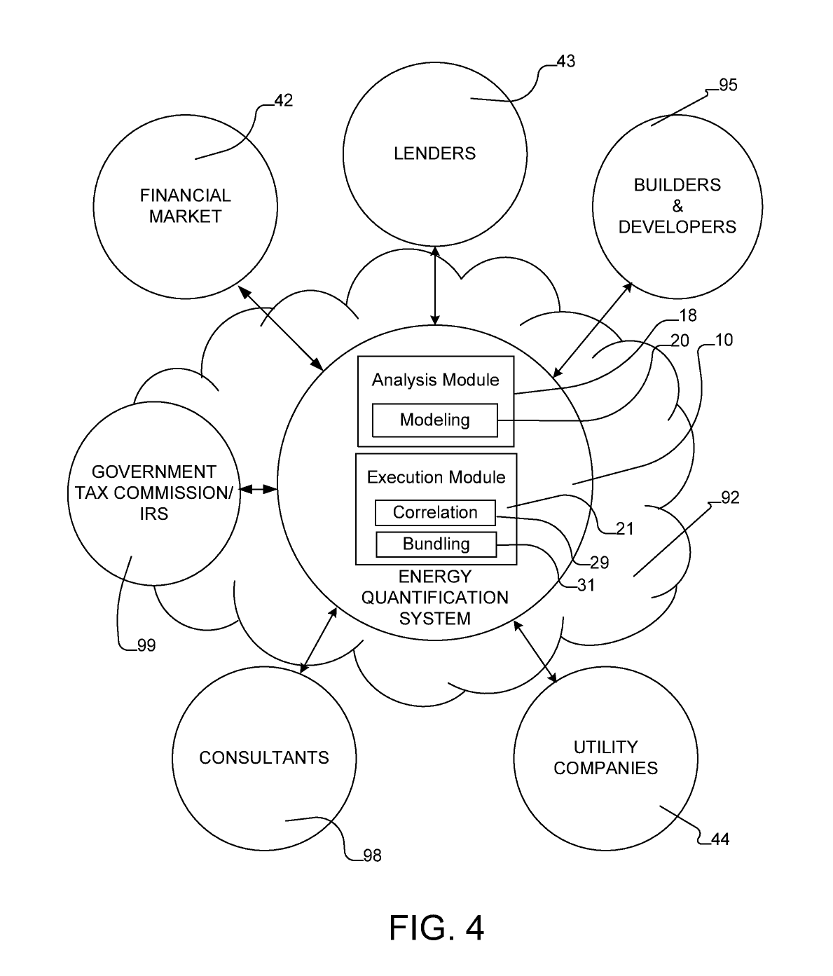

FIG. 4 is a diagrammatic view illustrating how the EQS 10, in accordance with embodiments of the present invention, may be interconnected with a variety of entities that are interested in participating in the programs and methods associated with the system. Indeed, the system 10 and related methods may be made available universally to any and all interested entities. For example, data and instructions may be communicated over a network 92 such as the Internet and/or a telephone network. The network 92 may include wired and wireless connections. As shown in FIG. 4, whether the EQS 10 is located at a location of the mortgagee, mortgagor, some other location, or at a combination of locations, the system 10 may be operably connected over the network 92 to a variety of interested entities including entities in the financial markets 42, lenders 43, and utility companies 44. Other interested entities may include builders and developers 95, consultants 98, and government agencies 99 such as tax commissions and/or the Internal Revenue Service (IRS).

As described above, the EQS 10 includes an analysis module 18 for calculating energy usage/energy savings, and an execution module for applying the savings to a financial transaction. The analysis module 18 may include a modeling module 20 for modeling the savings/incentives to users. The system 10 also includes the execution module 21, as discussed above. As shown in FIGS. 1 and 4, the execution module 21 may include a correlation module 29 for correlating all the available green incentives with each of the green construction projects. The execution module may also have a bundling module 31 to facilitate modeling of the savings/incentives to users and for bundling savings/incentives in attractive and concrete ways. In some embodiments, the correlation module 29 and the bundling module 31 may not form part of the execution module 21. In another embodiment, the bundling module 31 may be configured to bundle the incentives based on eligibility of at least one of the parties of interest. In any case, these modules make the payback mechanisms clear and viable for the financial market 42 and the lenders 43. For example, if a financial institution can easily have numerous incentives automatically quantified and bundled to have a definite value through the EQS 10, then the financial institution will readily use the system 10 to identify the effectual savings, consider improved rates for loans, and otherwise pass at least some of the savings along to consumers, developers, and others. Thus, the EQS 10 forms a bridge or nexus platform between the builders and developers 95 on one hand and the financial market 42 and the lenders 43 on the other hand with regard to green or sustainable energy construction projects. The systems and methods are presented with a high degree of visibility and transparency resulting in positive public relations for all types of users of the system 10 for continuing in or entering the emerging green/sustainable energy markets.

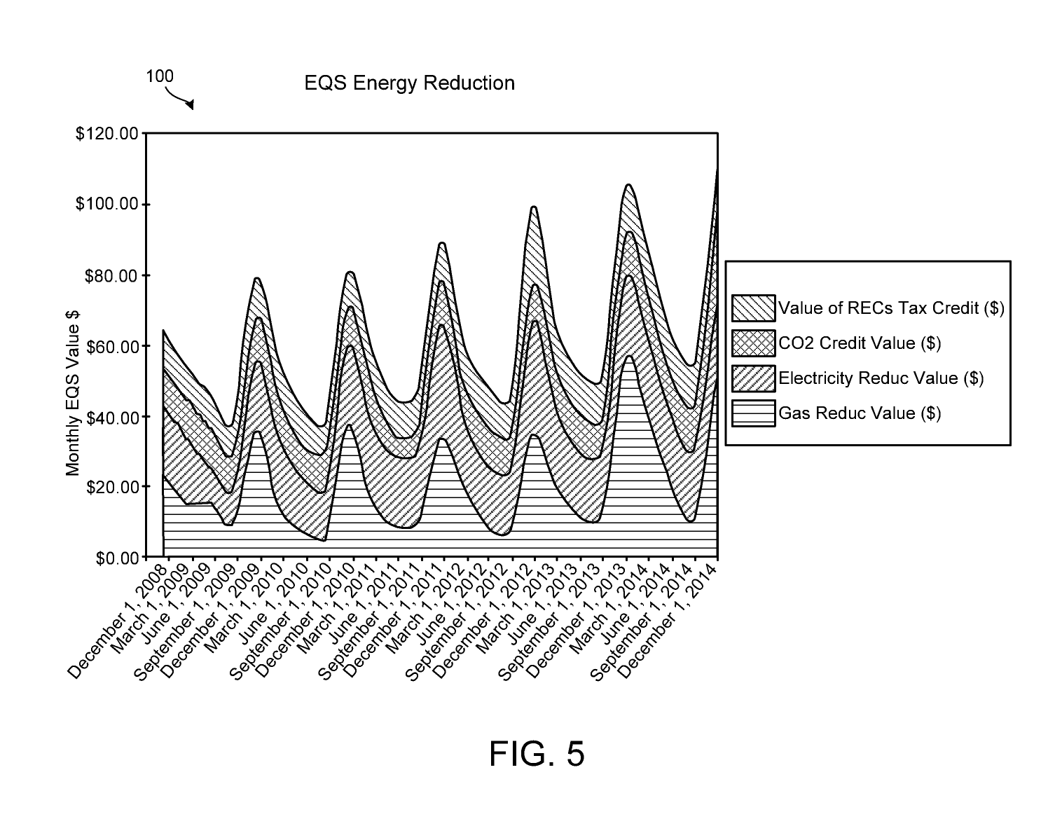

For example, referring back to Equation 2, a visual illustration in the form of a graph 100 shown in FIG. 5 makes clear the energy reduction value (ERV) for a particular building or retrofit project. As shown, there is more overall energy saved during the winter months even though more electricity is used and saved during the summer for the particular building and in the climate selected. The dollar value of the savings is indicated by the curve of the graph as compared with the amounts shown on the left hand side of the graph 100. Thus, the energy savings becomes clear to the user, and he/she can readily understand an average savings that will be available to be applied to repayment of a loan or another financial transaction such as application of the savings to purchase of a tradable commodity.

The system 10 and methods in accordance with embodiments of the present invention also bring together resources and benefits from the financial sector, well-established Internet based platforms and entities, renewable energy policy makers, and energy raters. In one embodiment, resources and benefits are made available together in a single site on an Internet Website. In exchange for the benefits of using these resources from a single place and the other advantages of the systems and methods describe herein, users may be required to pay fees. These fees may include one or more of membership fees, licensing fees, royalty fees, and product override fees/marketing fees for green/sustainable products. An example of a benefit that users will most likely be willingly to pay for through these fees is the creation of baselines for the green financial models. These baselines are needed by the financial and real estate markets for more universal entry into the green/sustainable building markets. Fees for using the energy quantification databases, which may include these baselines, may also be charged, and may be charged automatically. Owners of Internet-based applications supporting the systems and methods may charge fees for the development and maintenance of the applications. These fees may be passed through to users in addition to directly associated fees such as mortgage loan fees to help cover business costs.

In one embodiment, the EQS 10 includes machine-readable code supported on a server remote from the mortgagee and the mortgagor. In this embodiment, consultants 98 may use the EQS 10 to help builders and developers 95 to benefit from utility savings programs. In accordance with this embodiment, individuals or corporations wishing to conserve energy or to become energy producers in their building projects can access the needed information and become participants in the utility savings programs including programs that are set up to help mortgagees pay off their mortgages early, or set up reduction guarantees to mortgage payments. In this regard the system 10 may be supported on a platform that is universally available. For example, the platform may be a Web-based platform. Such a platform may be developed from scratch or the method may be implemented on existing platforms that are already well known and universally accessible. In any case, the system 10 and method 65 may be platform independent. In other embodiments, depreciation and green tax credit values may be considered and/or included in an EQS energy reduction.

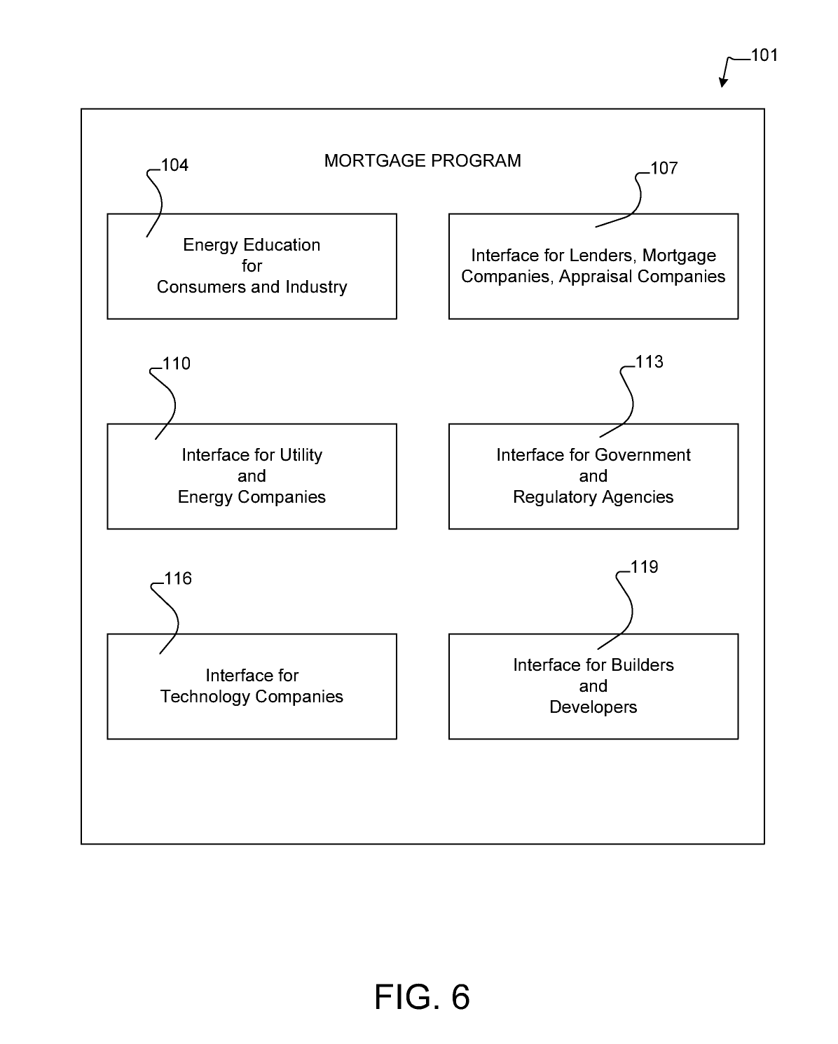

FIG. 6 is a diagrammatic view of an example of at least a portion of a program 101 that is available to interested entities. In this example, the program 101 is a mortgage program. Such a mortgage program may be embodied in a mortgage module 30 as shown in FIG. 1. As described above, the mortgage module 30 may be located at the mortgagor or the mortgagee, or may be located at a separate location such as on a server on the Internet. The mortgage program may include energy education for consumers and the industry 104. In addition to benefiting the public as an educational tool, the energy education and its presentation through the systems and methods described herein also facilitate marketing of green/sustainable energy technologies, including the systems and methods described herein. The mortgage program 101 may also include several interfaces that are provided by respective submodules for communication and/or data transfer to and from interested entities. These entities may include lenders, mortgage companies, and/or appraisal companies as indicated at 107, utility and energy companies as indicated at 110, and government and regulatory agencies as indicated at 113. Other interested entities may include technology companies, builders, and developers, as indicated at 116 and 119. The machine-readable code and/or other digital processing mechanisms that at least in part make up the mortgage program 101 may be configured to be compatible with conventional software that is typically used by the various interested entities. Additionally or alternatively, compatible software may be provided, such as by a download, to each interested entity. Thus, data may be transferred and transactions may be executed without difficulty.

FIG. 7 is a method flow chart diagram illustrating one embodiment of a method 700 for integrating a utility baseline for financing a property energy reduction measure. The method begins and a loan applicant prequalifies 702 for a loan. A determination module performs 704 an energy audit to determine appropriate energy reduction measures, as previously described. A calculation module calculates 706 a utility baseline as previously described. A valuation module performs 710 an appraisal analysis, the appraisal analysis including a traditional value of a property and a current value of one or more energy reduction measures. A calculation module recalculated 712 the underwriting based on the appraisal analysis. Closing documents are signed 714 and the loan is recorded 716. A determination module may continue to monitor energy usage or consumption 718.

In other embodiments, the method 700 may include performing an energy audit inspection and report to quantify predicted savings. In another embodiment, the method 700 may include performing a baseline analysis between predicted savings and real time savings. Such a baseline analysis may provide increased accuracy of predicted savings by comparing prior predictions with real time performance. Over time, and iterations of an embodiment of this method 700, the accuracy of predicted savings may increase.

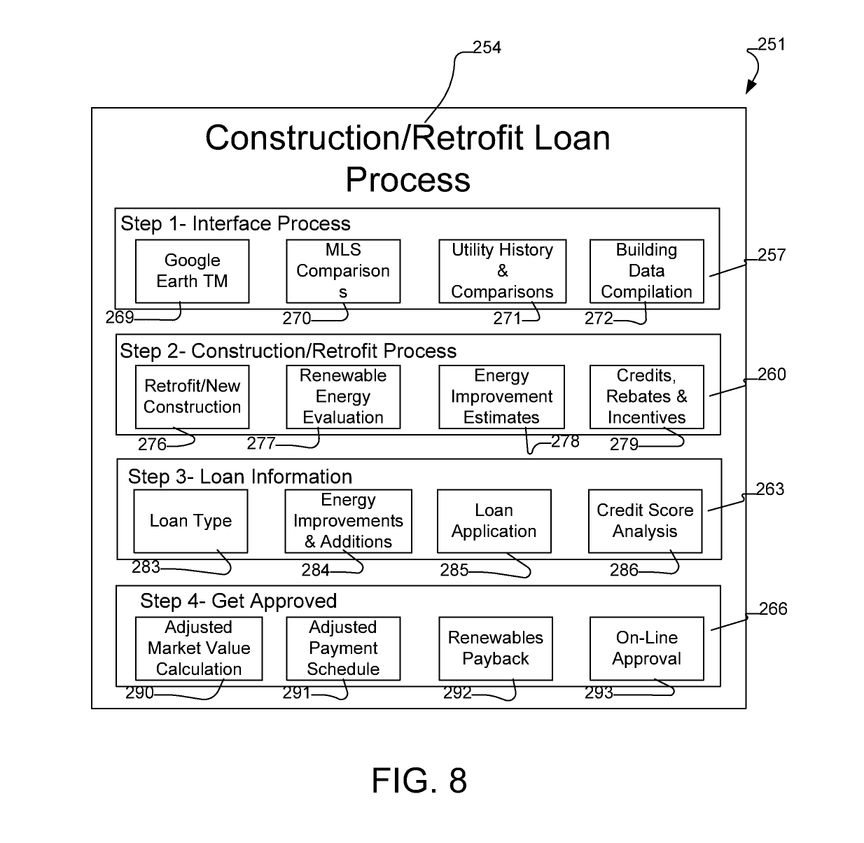

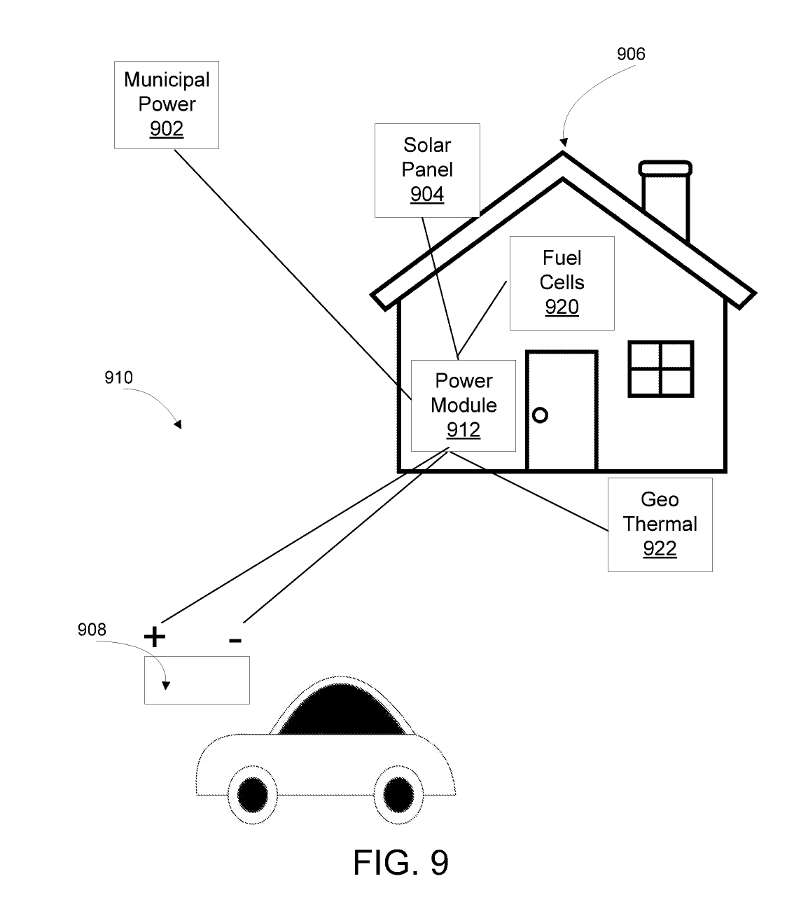

FIG. 8 is an example diagrammatic view depicting a user interface 251 that may be used to present the new construction/retrofit construction loan process with selectable options. The interface 251 may be in the form of a screen display having clickable soft buttons on a computer screen 254, for example. Each of these soft buttons may be associated with a module that performs the functions of the respective soft buttons. The user interface 251 does not necessarily depict all the same elements or flow paths for the loan process as are shown in FIG. 9 even though the user interface 251 is compatible with the process shown in FIG. 9. Rather, the user interface divides the loan process up into four main steps including an interface process 257, a construction/retrofit process 260, a loan information step 263, and an approval step 266.

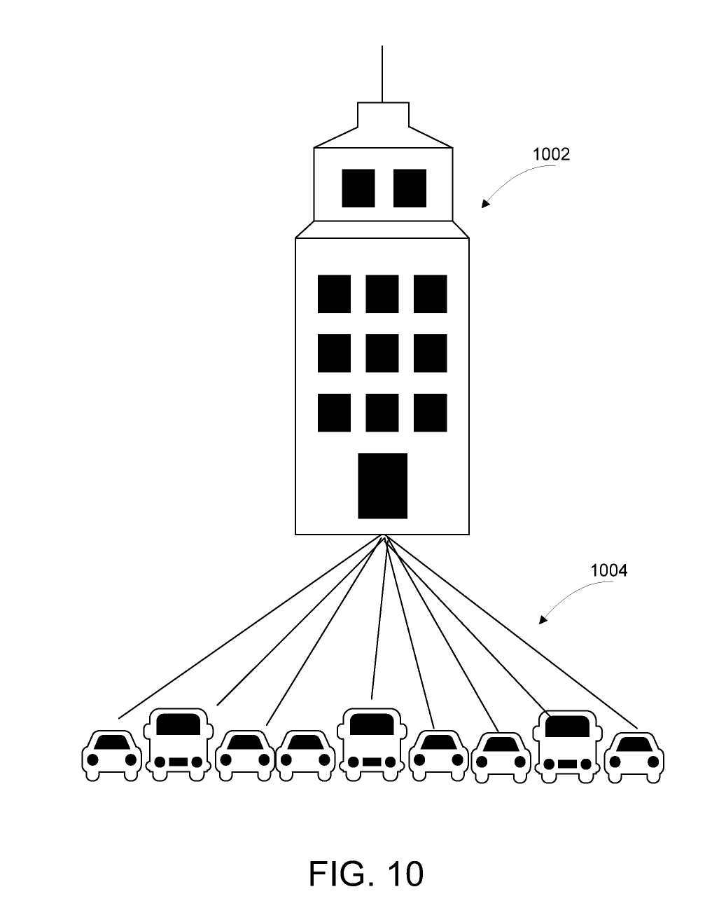

The interface process presents a user with clickable soft buttons including Google Earth™ 269, the multiple listing service (MLS) 270, and one or more databases. The interface process 257 shown in FIG. 10 includes a clickable link to utility history and comparisons 271 for utility usage in similar properties and/or constructions and a compilation of building data 272. With the soft buttons of the interface step 257, the user can look at a neighborhood through digital images on Google Earth™, compare pricing and other information through the MLS, and collect and analyze data from utility and building databases with the aid of the systems and methods of embodiments of the present invention. Additionally or alternatively, the interface step may include soft button links to regional climate databases and building construction databases to factor in climate and materials factors that affect energy savings, for example.

By clicking on the link 272 for compilation of building data, the user may be presented with a questionnaire that prompts the user to answer questions by filling spaces or checking boxes. In one example, a drop-down box may provide a selection to a user, where the user may select between a retrofit for an existing real property and a new construction model for energy performance measures. Of course, other types of projects may be included and this disclosure is not limited in this regard.

Alternatively, the soft buttons may include a button for assessing energy usage factors. Upon clicking such a link the user may be presented with a questionnaire addressing several categories of energy usage factors. One of the categories may be the building shell with fillable cells for: building type (commercial, residential, mixed use); size of building (square feet by floor), construction material (including thickness); number of floors; roof type; number, type, and orientation of doors; number, type, and orientation of windows; garage, building orientation; foundation type, insulation type-wall; insulation type-roof; insulation type-floor; and window sizes/types (R-U value) and orientation. Another category for energy factors may be climate zone with fillable cells for: latitude/longitude; altitude; daily high temperature; daily low temperature; daily average temperature; percent change from previous day; and average daily relative humidity. Another category may be HVAC and appliance with fillable cells for: type of heating system (BTU/kWh/Energy rating); type of cooling system (BTU/kWh/Energy rating); water heater type (BTU/kWh/Energy rating); and major appliances (kWh/Energy rating). Another category may be renewable energy sources with fillable cells for: solar electrical generation (type, output); solar water heating (capacity); geothermal (capacity); wind generator (type, output); and other (type, output, capacity). Another category may be major appliance with fillable cells for: refrigerator (BTU/kWh/Energy rating); stove (BTU/kWh/Energy rating); room air conditioner (BTU/kWh/Energy rating); televisions and computers (kWh/Energy rating); and other (BTU/kWh/Energy rating). Another category may be occupancy information with fillable cells for: number of inhabitants; and age group of the inhabitants (0-5, 6-11, 12-18, 18-25, 25-60, 60+). Another category may be utility information with fillable cells for: identify local utility companies; determine net-metering capability; average daily utility price (electricity/natural gas); and averaged comparables (conventional building energy use). The averaging of comparables may be achieved automatically based on selected comparable properties.

The entries prompted for, by the interface process 157 are needed for estimating energy usage and/or energy savings. This is a part of quantification, at least for qualifying for loans, tax incentives, or utility rebates. An example of data with which the input is to be populated is the climate data. Initially, the relational database may have limited information. However, over time, this data may be added to the database. Another area is the HVAC and appliances, data for which the relational database may be supplied from manufacturers. Similarly, data from renewable energy sources may be included in the database. Data for these and other inputs such as tax credits, carbon credits, and other incentives may be drawn from a myriad of sources to enable accurate quantification estimates for usage and savings.

The construction/retrofit process 260 also has clickable links including retrofit/new construction selection link 276, renewable energy evaluation link 277, energy improvement estimates link 278, and credits, rebates, and incentives 279. These links enable a user to select options that best fit the existing property or new building. The system analyzes the options selected in order to return results. For example, the user may select retrofit in link 276 and particulars for which the system prompts the user in the link 277. Link 278 is used to get estimates of costs for installing improvements. Link 279 may connect to stored information on various credits, rebates, and incentives, and the system may have instructions indicating which of the credits, rebates and incentives are available for a particular property and/or entity in a particular region, state, or country in which they are available.

After a user has elected through the aid of the system and user interface 251 the kind of construction 260, the system determines all the savings and/or incentive credits that are available and bundles or correlates them for further evaluation in the loan information step 263. The systems and methods identify the most affordable, highest performance, and most efficient green and sustainable energy technologies. Thus, the systems and methods identify good installations options for energy efficiency upgrades, justify those options, and ultimately capture associated capital investment gains. This bundling is region specific since incentives and rebates are specific to cities, counties, states, and countries. Bundling is also dependent on climate and other energy usage factors. Thus, the data is selected based on these and other specifics entered by the user. Based on the calculated information, the system allows the user to select the loan type through clickable link 283. The energy improvements are listed and may be modified such as by adding green or sustainable energy features through link 284. The user can click the loan application link 285 and fill in the loan application on-line, or at least print out a copy of the application for mailing or hand delivery. As part of the loan application step, or as a separate feature, a link 285 enables the user to run a credit check on-line through link 286.

Once the loan information step 263 has been completed, the user moves to the step of getting the loan approved 266. This step has several possible sub-steps including calculating the adjusted incremental market value by clicking the link 290. The increased market value achieved through the green and/or sustainable energy features applies a green premium value based on present value, future value or green price indices. Therefore, the increase value increases the property value, which in turn enables improved loan terms and provides financial markets with quality assets through quantified data. Once quantified, this increased market value can also translate into higher loan amounts since the property value is increased and payments may be reduced by the improved terms. The user may look at an adjusted payment schedule based on applying saving and/or incentives to early payoff of the loan by clicking link 291. The renewable energy payback link 292 shows savings and/or credits caused by the green and/or sustainable improvements. Clicking these links may initiate calculations, may pull up graphics, and/or present text representing calculations and analysis of energy savings and/or production. Once the benefits have been considered, the user may click the link 293 to initiate on-line approval of the loan. Clicking the on-line approval link 293 may cause the terms of the loan to be presented to the user for approval and lock in. Thus, most if not all of the loan process for green and/or sustainable energy improvement constructions may be done on-line in a seamless automated system. The information that has been input and the information coming from the analysis are stored in a user and/or property profile for subsequent use and/or update.

Larger entities such as large financial institutions and other large corporations may benefit from carbon credits that may be collected for an entire state or region, for example. A trading mechanism is derived from the regional presence of some financial institutions. The EQS 10 provides the quantification and bundling of incentives that facilitates use of the regionally based trading mechanism for a particular party of interest. That is, the EQS 10 opens the door for these large financial institutions because of their regional lending capacity and their ability to benefit from carbon credits on a regional basis to obtain the tradable credits, for example. These financial institutions can then offer lower interest rates to consumers and higher returns for their investors/secondary markets. Some of the costs to the financial institutions may also be tax deductible, further improving their profitability. Similarly, developers 324 can take advantage of RECs based on an entire region to offset infrastructure costs for increasing renewable energy production capacity through green construction projects.

Corporations benefit from trading mechanisms derived by upgrading existing buildings and reducing carbon emissions. Corporations, trade centers, shopping malls, universities, condominium communities, and other entities with very large buildings and other large energy using facilities may benefit from energy savings improvements directly and indirectly from carbon credits and/or renewable energy credits earned through implementing the improvements. The effectual savings offset or absorb cost outlays made for the improvements.

In one model, a community may form a centralized power generation (CPG) and distribution facility for the community. The EQS 10 is capable of modeling community energy provider potential and redistribution potential. All city government buildings, residences and businesses may be powered by the CPG. The CPG may have a capacity for producing an amount of renewable energy greater than is needed in the community. Thus, the CPG may distribute energy to nearby communities that do not have renewable energy production capability. Alternately, the excess energy generation may be used to fuel transit or electric vehicles. This model may be applied to design and construction of whole cities, and EQS 10 may provide grid blue prints and cost analysis for such cities.

Consumers or mortgagees may take advantage of a plurality of available consumer tax incentives and rebates. These credits may be applied to mortgage payment reduction, mortgage reduction, mortgage costs reduction, mortgage acceleration by payments over time, and/or paying down the mortgage balance in lump sums, as described herein. This offsets the cost of equipment and energy upgrades for the consumer or mortgagee.

There are a wide variety of local, state, and national tax credits (including tax deductions) available to the several parties of interest. The EQS 10 is a practical tool for accessing the trading mechanisms that these incentives create. Thus, the EQS 10 makes upgrading existing buildings, reducing carbon emissions, and otherwise building green a real and practical option.

FIG. 9 is an illustration depicting one embodiment of a transit system integrated with a real property. In one embodiment, the real property may be a single family dwelling 904 and the transit system 910 may be an electric vehicle. An analysis module 18 may be configured to quantify a value of the transit system 910 and a value of the real property 906. In another embodiment, the value of the transit system may be based on one or more green incentives as previously described regarding FIG. 1. In another embodiment, the analysis module 18 may quantify a value of a green construction project without user intervention, and the execution module 21 may apply the value without user intervention.

In another embodiment, a bundling module 31 may be configured to integrate the value of the transit system 910 with the value of the real property 906 according to at least one party of interest. In a further embodiment, the bundling module may integrate the value of the green construction project without user intervention. In one embodiment, an execution module 21 may be configured to apply the integrated value to at least one financial transaction on behalf of the at least one party of interest. In one example, the financial transaction is a mortgage for purchasing the integrated real property including the transit system. In another example, the financial transaction is a construction loan to install a transit system 910 on a real property 906.

In one embodiment, there may be many parties of interest associated with the financial transaction. For example, the parties of interest may include financial institutions, developers, investors, utility companies, building owners, or the like. In this embodiment, the bundling module 31 may be configured to associate the integrated value of the transit system 910 and the real property to respective parties of interest. For example, a financial institution and a real property 906 owner may equally share risk associated with a construction project involving the transit system 910 and the real property 906. In another example, a building contractor may cooperate with a real property owner to integrate the transit system 910 with the real property 906. Of course, any combination of two or more parties of interest may cooperate in the integration or construction of such a system.

In another embodiment, the execution module 21 may be configured to apply the integrated value to financial transactions involving respective parties of interest. In one example, a green construction project may be funded by a utility company and a real property owner. In this example, the execution module 21 may apply the integrated value based on respective investment portions of the utility company and the real property owner.

In one embodiment, the transit system 910 may include an electric vehicle including a battery 908. The battery 908 of the electric vehicle may provide backup power to the real property 906. In one example, transit system 910 may be a hybrid vehicle, whereby driving the hybrid vehicle charges a battery 908 for the vehicle. Therefore, a battery 908 for a transit system may provide electrical power for the real property which may require the real property 906 to require less electrical power from the utility, such as, but not limited to, a municipal power source 902.

In another embodiment, a green construction project may include a solar panel 904 that may be configured to provide power to a power module 912 for a real property 906. In one example, the solar panel 904 may provide more power than required for the real property 906. Therefore, the power module 912 may direct additional electrical power to the transit system 910 for charging a battery 908 of the transit system 910.

In another embodiment, the real property 906 may generate more electrical power than it consumes. Therefore, electrical power may be stored, or distributed by the power module 912 back onto a power grid, or back to a municipal power 902. In one embodiment, the power module 912 may monitor power usage for the transit system, the real property, other energy generation device, such as, but not limited to, a solar panel 904, a wind turbine, hydro-electric power generation, or the like.

In another example, a transit system 910 may include a hydrogen powered automobile. Electrical power from the solar panel 904 may disassociate water molecules to generate oxygen and hydrogen. The hydrogen may be used to fuel the hydrogen powered automobile. Therefore, the transit system 910, in one embodiment, may receive a substantial portion of its required energy from the real property 906 or energy generation systems integrated into the real property.

In another example, fuel cells 920 may be included in the real property. In this example, the fuel cells 920 may also be used to generate electrical energy. In certain examples, the fuel cells may convert chemical energy into electricity through a chemical reaction with oxygen or another oxidizing agent. The fuel cells 920 may be based on hydrogen, hydrocarbons such as, but not limited to natural gas, and/or alcohols, such as, but not limited to, methane, or the like. The fuel cells 920 may include any fuel cell design, such as, but not limited to, proton exchange membrane, phosphoric acid, high-temperature, SOFC, MCFC, a to be developed fuel cell, or any combination, or other, or the like, as one skilled in the art may appreciate.

In another example, geo-thermal 922 energy may be captured by one or more systems associated with the real property. Geo-thermal energy may be generated from heat stored in the ground. Geo-thermal heat from the earth's crust may be captured and used to generate electricity as one skilled in the art may appreciate.

In another embodiment, the bundling module 31 may be further configured to include a value of a green construction project associated with respective parties of interest for a specified geographic region, wherein the green construction project includes building the transit system 910. Therefore, a group of real property owners in a similar geographic region may cooperate in a green energy project. In one example, a green energy project may include a large wind turbine that generated electrical power. Each of the property owners in the nearby group may have electric vehicles integrated with their respective properties. The electrical power from the wind turbine may be distributed to the group of real property owners such that the wind turbine charges respective electric vehicles in the group. Therefore, parties of interest for a green construction project may include multiple property owners, wherein a portion of the green construction project is attributable to each of the respective parties of interest as previously described. In another embodiment, a correlation module 29 may be configured to correlate one or more green incentives to the green construction project.

FIG. 10 is another illustration depicting one embodiment or a transit system integrated with a real property. In one example, the transit system includes a mass transit system, such as, but not limited to, many automobiles 1004, buses, light rail, air transportation, or the like. In this embodiment, the transit system includes a mass transit system and the real property 1002 is a commercial building and energy generated by the commercial building provides power to the mass transit system.

In another embodiment, the real property 1002 may be a multi-family dwelling, such as, but not limited to, an apartment complex, a hotel, a motel, a duplex, a trailer park, a recreational vehicle park, a campground, or other, or the like. In one example, energy generated by one portion of the multi-family dwelling may be routed to energy consumption devices at other units of the multi-family dwelling. In this manner, many co-located dwellings may cooperate in their energy production and consumption. In related embodiments, a green energy project may include green energy modification to multiple of the units of the multi-family dwelling.

In certain examples, a central charging station may receive energy from multiple energy producers. The central charging station may provide electrical energy to other units of the multi-family dwelling, or the like. Furthermore, depreciation, tax credits, carbon credits may be effectively shared and quantified. Various credits may be applied to mortgages for the units of the multi-family dwelling as described herein.

In one embodiment, the correlation module 29 may be configured to selectively combine two or more green incentives into a package. In this embodiment, a bundling module may be configured to combine the packages into a bundle associated with a party of interest based on the green construction project and a new building construction. In one embodiment, a building constructor may propose a green construction project that includes an integrated transit system with a real property. In one embodiment, a financial transaction, such as a mortgage, may include the value of the transit system as well as the value of the real property. Furthermore, green energy generation systems may be included in the mortgage as previously described.

In one embodiment, the correlation module 29 may be configured to correlate all green incentives that are available to the green construction project. In one example, the green incentives may be national tax credits, national tax deductions, state tax credits, state tax deductions, local tax credits, local tax deductions, municipal bonds, utility company buy backs, carbon credits, renewable energy credits, or the like. In another embodiment, the analysis module 18 may be configured to quantify a value of each of the green incentives that are available.

In another embodiment, the execution module 21 may be configured to apply for the green incentives to a government body. For example, the execution module may apply for the green incentives from a national government, a state government, a local government, a carbon credit securities agency, a utility company, or the like. In one embodiment, the execution module 19 may also include a forms module 28 that accesses many forms corresponding to a respective many recipients. A forms module 28 may also be configured to automatically fill in at least a portion of the form.

In one embodiment, an analysis module 18 may be configured to determine a baseline value and compare a usage of at least one utility to the baseline value and calculate an energy savings. In another embodiment, the analysis module 18 may add the value of the green incentive to the energy savings for an effectual energy savings value. Also, an execution module 21 may be configured to apply a portion of the effectual energy savings value to the financial transaction. In another example, the real estate and related equipment may be collateralized, securitized and/or monetized.

In another embodiment, a module may convert the value of a green incentive and a unit of energy usage for a utility into a single common unit of at least one of energy and currency. In one embodiment, a mortgager module 62 may be configured to set terms of a loan and apply a portion of a green incentive to repay the loan. In a further embodiment, the analysis module 18 may be configured to predetermine a baseline value of energy usage for the real property before the green construction project, and quantify at least one of an actual energy usage and a predicted energy usage for the real property after the green construction project. The analysis module 18 may also compare that actual and the predicted energy usage to the predetermined baseline value, and determine a savings of energy. In another embodiment, the analysis module 18 may be configured to save at least one of the base line value, actual energy usage, predicted energy usage, and energy savings to a database.

Referring back to FIG. 10, in one embodiment, the commercial building 1002 may include various kinds of energy generation devices or systems as previously described. In one example, the various energy generation device produce electrical energy and the electrical energy may be used to charge batteries in a fleet of electric vehicles, or electric buses, or an electric light rail, or the like. In another example, the various energy generation devices may produce another form of energy, such as, but not limited to, hydrogen generation, or the like. In this example, a fleet of hydrogen powered automobiles, buses, or the like, may be fueled using hydrogen collected by the various energy production devices.

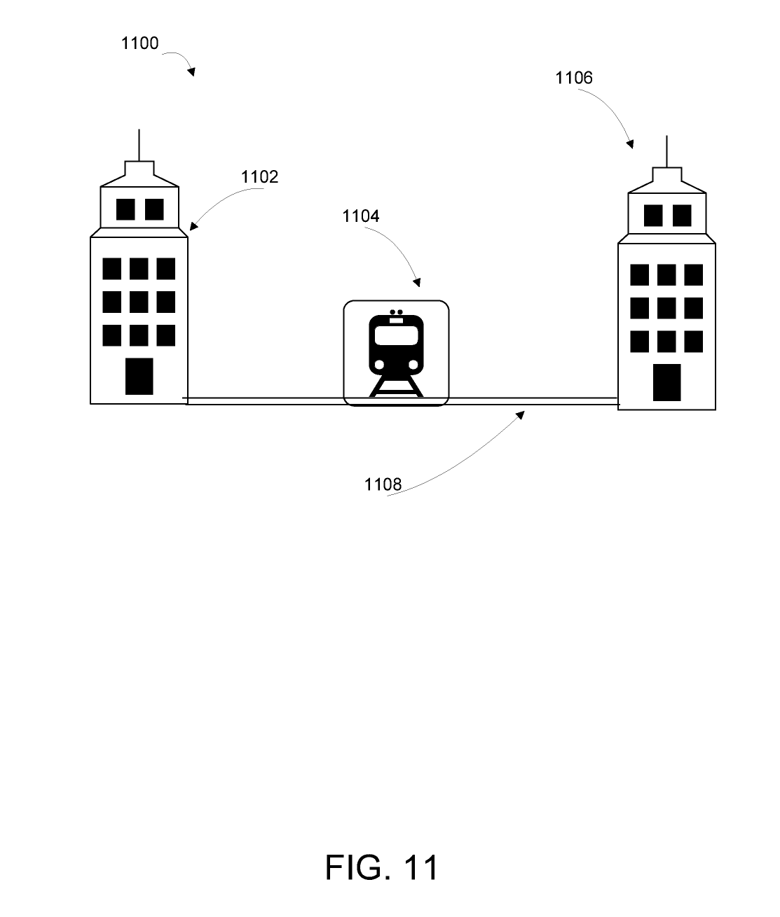

FIG. 11 is an illustration depicting one embodiment 1100 of a transit system 1104 integrated with a real property 1102, 1106. In one embodiment 1100 the transit system 1104 may include a light rail train 1104. The light rail train 1104 may be connected between two or more buildings 1102, 1106 by a fixed railway system 1108 associated with the real property. Each of the buildings 1102, 1106 may be retrofitted with green energy systems that generate energy. The energy systems of the buildings 1102, 1106 may provide power or fuel to the transit system 1104.

In another embodiment, the commercial building 1102 and the commercial building 1106 may be owned by different entities. Therefore, two or more real property owners may cooperate to integrate a transit system 1104 for both real properties. Furthermore, an analysis module may quantify the value of the transit systems and coordinate the values of different real properties associated with the transit system based on percentage of ownership, or similar. Also, a bundling module may consider a portion of ownership in a transit system for two or more real properties, and bundle the values accordingly. In another embodiment, an execution module may apply the portion of interest for one of the real property owners in a financial transaction for the real property.

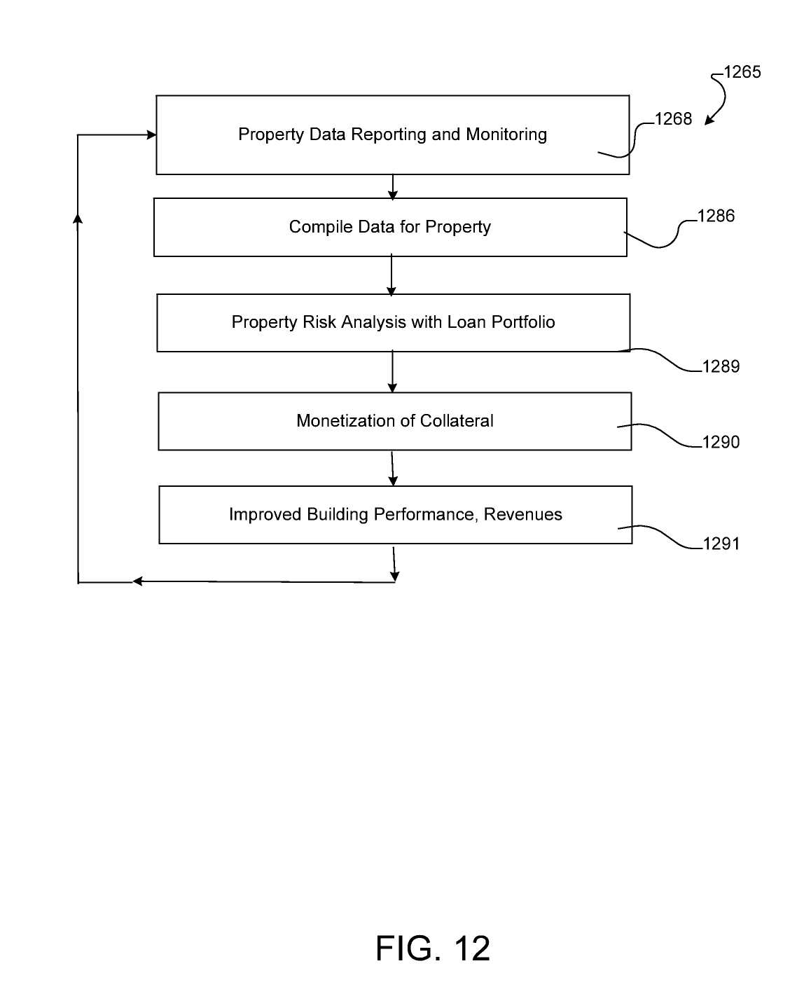

FIG. 12 is a block diagram illustrating embodiments of a method 1265 for determining a utility savings and applying the savings to a financial transaction. In one embodiment the method includes reporting and monitoring 1268 property data for a real property. The method 1265 may compile 1286 data for the real property. Compiling data for the real property may include tracking, recording, measuring energy usage for each of the available utilities. The method 1265 may analyze 1289 a risk associated with a green energy project for the real property. In another embodiment, the risk associated with a green energy project may be based on one or more available green incentives.

In another embodiment, the method includes Monetization 1290 of collateral. Monetization of collateral may include applying various valuation strategies to collateral associated with a financial transaction. In one embodiment, the method 1265 may include improved building performance based on the integration of a transit system for the real property, where the transit system provides a measureable benefit to the real property. In one example, an electric vehicle may provide backup electrical power for the real property.

In another embodiment, the method 1265 may include improved 1291 building performance and revenues. Building performance may be measured by monitoring energy usage over a period of time after a green energy project. Revenues may be calculated by measuring an energy surplus minus a portion of the revenue used to pay a portion of a payment for a loan. In another embodiment, a revenue may be a portion of energy remaining after a portion is applied to a payment for a loan. In another embodiment, after a loan for a financial transaction has been paid in full, revenues may be calculated based on energy surplus usage. In another embodiment, a revenue stream may be instituted based on the energy savings. This may result in an energy distribution and trading scheme without a securitization model.

The present invention may be embodied in other specific forms without departing from its spirit or essential characteristics. In fact, the embodiments or portions thereof may be combined in any way. The described embodiments are to be considered in all respects only as illustrative and not restrictive. The scope of embodiments of the invention is, therefore, indicated by the appended claims rather than by the foregoing description. All changes which come within the meaning and range of equivalency of the claims are to be embraced within their scope.

What is claimed is:

1. An apparatus comprising a computer program storage medium readable by a processor and embodying one or more instructions executable by a processor, the instructions comprising:
an analysis module configured to quantify a value of a green transit system and a value of a real property, the value of the transit system based on one or more green incentives;
a bundling module configured to integrate the value of the transit system with the value of the real property according to at least one party of interest; and
an execution module configured to apply the integrated value to at least one financial transaction on behalf of the at least one party of interest.

2. The apparatus of claim 1, further comprising a plurality of parties of interest including the at least one party of interest, wherein:
the parties of interest are from the group consisting of financial institutions, developers, utility companies, and building owners associated with the real property;
the bundling module is configured to associate the integrated value to the respective parties of interest; and
the execution module is configured to apply the integrated value to financial transactions involving the parties of interest.

3. The apparatus of claim 2, wherein the bundling module is further configured to include a value of a green construction project associated with respective parties of interest for a specified geographic region, the green construction project comprising building the transit system.

4. The apparatus of claim 1, further comprising a correlation module configured to correlate the one or more green incentives to the green construction project.

5. The apparatus of claim 1, wherein the transit system comprises an electric automobile and the real property comprises a single family dwelling, the electric automobile providing backup electrical power to the single family dwelling.

6. The apparatus of claim 1, wherein the transit system comprises a mass transit system and the real property comprises a commercial building and energy generated by the commercial building provides power to the mass transit system.

7. The apparatus of claim 4, wherein:
the correlation module is configured to selectively combine two or more of the green incentives into a package; and
the bundling module is configured to combine a plurality of packages including the package into a bundle associated with the party of interest based on the green construction project and a new construction on the real property.

8. The apparatus of claim 7, wherein the correlation module is configured to correlate all green incentives that are available to the green construction project, the green incentives being from the group consisting of national tax credits, national tax deductions, state tax credits, state tax deductions, local tax credits, local tax deductions, municipal bonds, utility company buy backs, carbon credits, and renewable energy credits, and the analysis module is configured to quantify a value of each of the green incentives that are available.

9. The apparatus of claim 1, wherein the execution module is configured to apply for the green incentive to at least one of a national government, state government, local government, carbon credit securities agency, and utility company, and the execution module further comprises a forms module that accesses at least one form with which to apply for the green incentive, the forms module accessing a plurality of forms corresponding to a respective plurality of recipients, the forms module configured to automatically fill in at least a portion of the forms.

10. The apparatus of claim 1, further comprising a securities exchange module configured to apply for carbon credits based on carbon emissions reduction.

11. The apparatus of claim 1, further comprising a securities exchange module configured to enable purchase and sell of at least one of carbon credits, energy conserving incentive values, and energy generating incentive values.

12. The apparatus of claim 1, wherein
the analysis module is configured to determine a baseline value and compare a usage of at least one utility to the baseline value and calculate an energy savings,
the analysis module adds the value of the at least one green incentive to the energy savings for an effectual energy savings value, and
the execution module is configured to apply at least a portion of the effectual energy savings value to the financial transaction.

13. The apparatus of claim 1, wherein at least one of the modules is configured to convert the value of the green incentive and a unit of usage for a utility into a single common unit of at least one of energy and currency.

14. The apparatus of claim 1, further comprising a mortgagor module including at least a portion of one of the analysis module and the execution module, the mortgagor module configured for setting terms of a loan and applying at least a portion of one of the green incentives to repayment of the loan.

15. The apparatus of claim 1, wherein
the analysis module is configured to predetermine a baseline value of energy usage for the real property before the green construction project,
the analysis module further configured to
quantify at least one of an actual energy usage and a predicted energy usage for the real property after the green construction project,
compare the at least one of the actual and the predicted energy usage to the predetermined baseline value, and
determine a savings of energy,
wherein the execution module is further configured to save at least one of the base line value, actual energy usage, predicted energy usage, and energy savings to a database.

16. The apparatus of claim 1, wherein the bundling module is configured to bundle the incentives based on eligibility of at least one of the parties of interest.

17. A method comprising:
quantifying, without user intervention, a value of a green construction project, the green construction project comprising a transit system, the green construction project modifying a real property to integrate the transit system, the quantifying also including one or more green incentives;
bundling, without user intervention, the value of the green construction project for at least one party of interest; and
applying, without user intervention, the value of the green construction project to one or more financial transactions involving the party of interest.

18. The method of claim 17, further comprising automatically charging a fee to the at least one party of interest for using the method, wherein the party of interest is selected from the group consisting of a financial institution, a developer, a utility company, a real estate trust, a corporation, and real property owners.

19. The method of claim 17, further comprising absorbing an infrastructure cost for the green construction project by applying at least a portion of the one or more green incentives to payment of the infrastructure cost.

20. The method of claim 17, further comprising:
quantifying at least one of an actual energy usage and a predicted energy usage for the real property after the green construction project,
comparing the at least one of the actual and the predicted energy usage to the predetermined baseline value, and
determining a savings of energy, wherein the quantifying further considers the savings of energy.
